(19) United States
(12) Patent Application Publication
(10) Pub. No.: US 2025/0010414 A1
(43) Pub. Date: Jan. 9, 2025

(54) FASTENING ASSEMBLY

(71) Applicant: ILLINOIS TOOL WORKS INC., Glenview, IL (US)

(72) Inventors: Chen LI, Shanghai (CN); Zhilin LI, Shanghai (CN)

(21) Appl. No.: 18/764,488

(22) Filed: Jul. 5, 2024

(30) Foreign Application Priority Data
Jul. 6, 2023 (CN) 202310827249.9
Jun. 26, 2024 (CN) 202410841356.1

(51) Int. Cl. B23P 19/10

(52) U.S. Cl. CPC B23P 19/10

(57) ABSTRACT

The present disclosure discloses a fastening assembly having a housing, a positioning body, an adjustment member, and a motion converter. The housing defines a housing cavity. The positioning body is accommodated inside the housing cavity and is movable relative to the housing in a first direction. The adjustment member is rotatable around an axis of the adjustment member relative to the housing. The motion converter is configured such that the rotation of the adjustment member around the axis of the adjustment member drives the positioning body to move relative to the housing in the first direction. The fastening assembly of the present disclosure can connect a first part to a second part with a first part hole and a second part hole positioned with deviations from preset positions, and enable the connected first and second parts to be in the preset positions.

### RELATED APPLICATIONS

The present application claims the benefit of Chinese Patent Application Nos. 202310827249.9, filed Jul. 6, 2023, and 202410841356.1, filed Jun. 26, 2024, each titled “Fastening Assembly,” the contents of which are hereby incorporated by reference.

### BACKGROUND

The present disclosure relates to a fastening assembly. In the prior art, a fastening assembly is used to connect a first part to a second part. The first part is provided with a first part hole and the second part is provided with a second part hole. However, in some situations (e.g., with machining errors when machining the holes), the position of the first part hole and the position of the second part hole deviate from preset positions, resulting in that the first and second parts cannot be placed in the preset positions when the first and second parts are connected to each other.

### SUMMARY

The present disclosure generally relates to a fastening assembly, substantially as illustrated by and described in connection with at least one of the figures, as set forth more completely in the claims. Exemplary aspects of the present disclosure can solve at least some of the above problems.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastening assembly according to a first aspect of the present disclosure.

FIG. 1B is a vertical cross-sectional view of the fastening assembly shown in FIG. 1A.

FIG. 1C is an exploded view of the fastening assembly shown in FIG. 1A.

FIG. 2 is a perspective view of a housing shown in FIG. 1C.

FIG. 3 is a perspective view of a positioning component shown in FIG. 1C.

FIG. 4 is a perspective view of a slider shown in FIG. 1C.

FIGS. 5A-5B are perspective views of an adjustment member shown in FIG. 1C in different orientations.

FIG. 6 is a cross-sectional view of the fastening assembly.

FIG. 7A is a front view of the first aspect of the fastening assembly with the adjustment member in an initial position.

FIG. 7B is a cross-sectional view of the first aspect of the fastening assembly with the adjustment member in the initial position.

FIG. 7C is a top view of the first aspect of the fastening assembly with the adjustment member in the initial position.

FIG. 8A is a perspective view of the first aspect of the fastening assembly with the adjustment member in a first extreme position.

FIG. 8B is a cross-sectional view of the first aspect of the fastening assembly with the adjustment member in the first extreme position.

FIG. 9A is a perspective view of the first aspect of the fastening assembly with the adjustment member in a second extreme position.

FIG. 9B is a cross-sectional view of the first aspect of the fastening assembly with the adjustment member in the second extreme position.

FIGS. 10A-10B are diagrams of a process of connecting a first part to a second part via the first aspect of the fastening assembly of the present disclosure.

FIG. 11 is a perspective view of a second aspect of the fastening assembly of the present disclosure.

FIG. 12 is a perspective view of a third aspect of the fastening assembly of the present disclosure.

FIG. 13A is an exploded view of a second aspect of a second motion conversion structure, a slider, and a positioning body of the present disclosure.

FIG. 13B is a vertical cross-sectional view of the second motion conversion structure of the second aspect, the slider and the positioning body shown in FIG. 13A.

### DETAILED DESCRIPTION

Various specific implementations of the present disclosure are described below with reference to the drawings which constitute part of this specification. It should be understood that although the terms indicating directions, such as “front”, “rear”, “upper”, “lower”, “left”, “right” and so on are used in the present disclosure to describe structural parts and elements in various examples of the present disclosure, these terms are used herein only for ease of description and are determined based on the exemplary orientations as shown in the accompanying drawings. Since the arrangements in the aspects disclosed in the present disclosure may be in various directions, these terms indicating directions are only illustrative and should not be considered as limitations.

The ordinal numbers such as “first” and “second” used in the present disclosure are merely used for distinguishing and identification, and do not have any other meanings. Unless otherwise specified, the ordinal numbers neither indicate a specific order, nor have a specific relevance. For example, the term “first motion conversion structure” does not in itself imply the existence of a “second motion conversion structure,” nor does the term “second motion conversion structure” in itself imply the existence of a “first motion conversion structure.”

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The present disclosure provides a fastening assembly, comprising a housing, a positioning body, an adjustment member, and a motion converter. The housing defines a housing cavity. The positioning body is accommodated inside the housing cavity and is movable relative to the housing in a first direction. The adjustment member is rotatable around an axis of the adjustment member relative to the housing. The motion converter is configured such that the rotation of the adjustment member around the axis of the adjustment member drives the positioning body to move relative to the housing in the first direction.

According to the fastening assembly described above, the axis of the adjustment member is substantially perpendicular to the first direction.

According to the fastening assembly described above, the motion converter comprises a slider, a first motion conversion structure, and a second motion conversion structure. The slider is accommodated inside the housing cavity and movable relative to the housing along the axis of the adjustment member The first motion conversion structure is provided on the adjustment member and the slider and configured to convert the rotation of the adjustment member around the axis of the adjustment member into movement of the slider along the axis of the adjustment member. The second motion conversion structure is provided on the slider and the positioning body and configured to convert movement of the slider along the axis of the adjustment member into movement of the positioning body in the first direction.

According to the fastening assembly described above, the positioning body is provided with a positioning body accommodating portion, and the slider is arranged inside the positioning body accommodating portion.

According to the fastening assembly described above, the first motion conversion structure comprises a threaded structure.

According to the fastening assembly described above, the threaded structure comprises an internal thread and an external thread which cooperate with each other. The slider is provided with an adjustment member hole, and an internal thread is provided on an inner wall of the adjustment member hole. The external thread is provided on the adjustment member.

According to the fastening assembly described above, the threaded structure comprises a first thread and a second thread having different cross sections.

According to the fastening assembly described above, the second motion conversion structure is configured such that the distance of movement of the positioning body along the first direction increases as the distance of movement of the slider along the axis of the adjustment member increases.

According to the fastening assembly described above, the second motion conversion structure comprises a first positioning component inclined portion and a second positioning component inclined portion formed by an inner wall of the positioning body accommodating portion, and a first slider inclined portion and a second slider inclined portion provided on the slider. The first positioning component inclined portion and the second positioning component inclined portion are located on opposite sides of the positioning body accommodating portion in the first direction, the first slider inclined portion and the second slider inclined portion are located on opposite sides of the slider in the first direction, the first positioning component inclined portion cooperates with the first slider inclined portion, and the second positioning component inclined portion cooperates with the second slider inclined portion. Each of the first positioning component inclined portion, the second positioning component inclined portion, the first slider inclined portion and the second slider inclined portion is an inclined surface with the same slope.

According to the fastening assembly described above, the second motion conversion structure comprises a first protrusion and a second protrusion provided on an inner wall of the positioning body accommodating portion, and a first slider cooperating portion and a second slider cooperating portion provided on the slider. The first protrusion and the second protrusion are located on opposite sides of the positioning body accommodating portion in the first direction and are formed by protruding from the inner wall of the positioning body accommodating portion, the first slider cooperating portion and the second slider cooperating portion are arranged on opposite sides of the slider in the first direction, the first protrusion cooperates with the first slider cooperating portion, and the second protrusion cooperates with the second slider cooperating portion. Each of the first slider cooperating portion and the second slider cooperating portion comprises at least one first stage section and at least one second stage section. The at least one first stage section is configured to increase the distance of movement of the positioning body in the first direction at a first speed with the increase of the distance of movement of the slider along the axis of the adjustment member. The second stage section is configured to increase the distance of movement of the positioning body in the first direction at a second speed which is different from the first speed with the increase of the distance of movement of the slider along the axis of the adjustment member.

The fastening assembly described above further comprises a limiting structure. The limiting structure is provided on the adjustment member and the housing and configured to limit a maximum angle of rotation of the adjustment member around the axis of the adjustment member.

According to the fastening assembly described above, the limiting structure comprises a tab provided on the adjustment member and a boss provided on the housing. The tab is formed by protruding outwardly from the adjustment member in a radial direction of the adjustment member, and the boss protrudes from a surface of the housing and has a first stop surface and a second stop surface arranged opposite each other in a circumferential direction of the axis of the adjustment member. The first stop surface and the second stop surface are capable of abutting against the tab to hinder the rotation of the tab.

According to the fastening assembly described above, the boss is provided with a boss accommodating portion. The fastening assembly is configured such that when the adjustment member and the housing are assembled in place, the tab is accommodated inside the boss accommodating portion.

The fastening assembly described above further comprises a positioning structure. The positioning structure is provided on the adjustment member and the housing and configured to hinder movement of the adjustment member relative to the housing.

According to the fastening assembly described above, the positioning structure comprises a plurality of raised ribs provided on the adjustment member and at least one groove provided on the housing. The plurality of raised ribs protrude from a surface of the adjustment member in a radial direction of the adjustment member around the axis of the adjustment member, the at least one groove is recessed in a surface of the housing, and any one of the plurality of raised ribs is capable of being accommodated inside the at least one groove to hinder movement of the adjustment member relative to the housing.

The fastening assembly described above further comprises an indicating structure. The indicating structure is configured to indicating a distance by which the positioning body moves relative to the housing in the first direction.

According to the fastening assembly described above, the indicating structure comprises an indicating area provided on the housing and a pointer provided on the adjustment member. The indicating area is arranged around the axis of the adjustment member, and the indicating area is provided with a plurality of numerical values thereon. When the pointer points at a numerical value of the plurality of numerical values, the numerical value represents the distance by which the positioning body moves relative to the housing in the first direction.

The fastening assembly described above further comprises a housing positioning member and a positioning pin. The housing positioning member enables the housing to be positioned relative to a first part in the direction of the axis of the adjustment member. The positioning pin is provided on the positioning body and formed by extending in the direction of the axis of the adjustment member to enable the positioning body to be positioned relative to a second part in the direction of the axis of the adjustment member.

The fastening assembly described above further comprises a housing positioning member and a positioning pin. The housing positioning member enables the housing to be positioned relative to a first part in a second direction substantially perpendicular to the axis of the adjustment member and the first direction. The positioning pin is provided on the positioning body and formed by extending in the second direction to enable the positioning body to be positioned relative to a second part in the second direction.

The fastening assembly described above further comprises a connecting component. The connecting component extends through the housing and is configured to connect a first part to a second part.

The fastening assembly of the present disclosure can connect a first part to a second part with a first part hole and a second part hole positioned with deviations from preset positions, and enable the connected first and second parts to be in the preset positions.

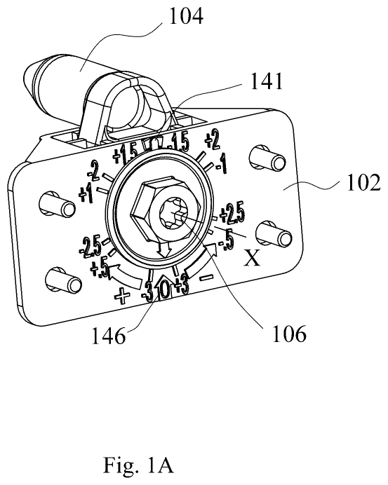

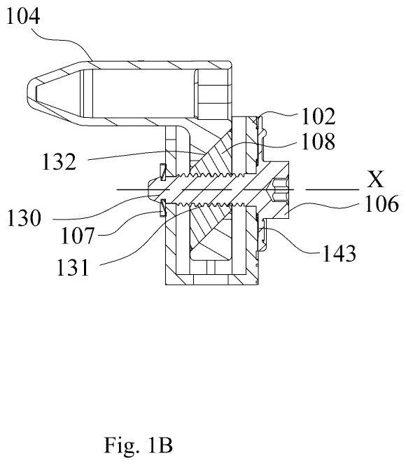

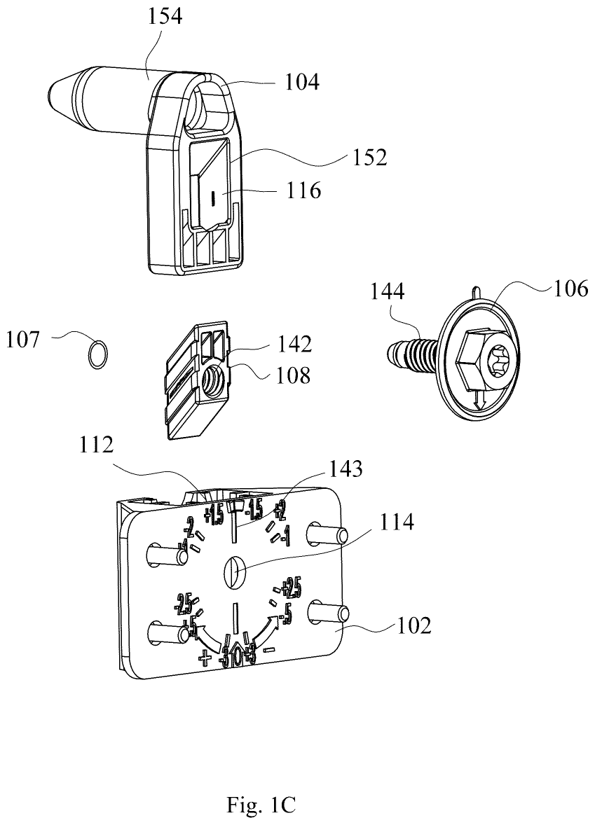

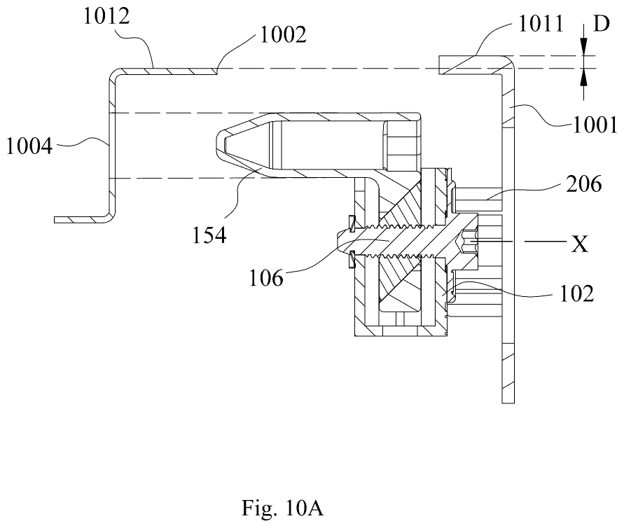

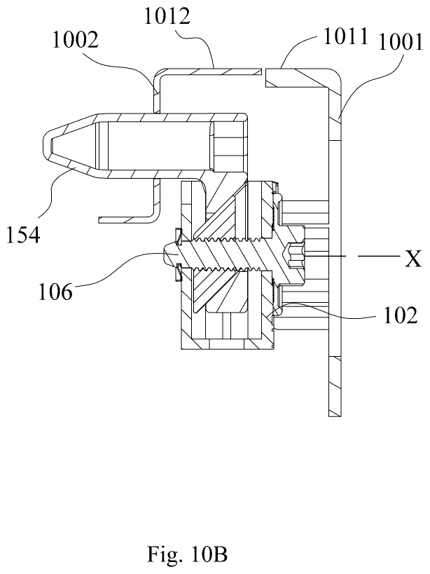

FIG. 1A is a perspective view of a fastening assembly according a first aspect of the present disclosure, FIG. 1B is a vertical cross-sectional view of the fastening assembly shown in FIG. 1A, and FIG. 1C is an exploded view of the fastening assembly shown in FIG. 1A. As shown in FIGS. 1A-1C, the fastening assembly comprises a housing 102, a positioning component 104, an adjustment member 106, a limiting member 107 and a motion converter 130. The housing 102 is configured to cooperate with a first part 1001 to be connected (see FIG. 10A). The positioning component 104 is configured to cooperate with a second part 1002 to be connected (see FIG. 10A). The housing 102 defines a housing cavity 112 and a hole 114. The housing cavity 112 is in communication with the hole 114. The positioning component 104 comprises a positioning body 152 and a positioning pin 154 connected to each other. The positioning component 104 can move relative to the housing 102 in a first direction (i.e., in a vertical direction). The positioning body 152 is accommodated in the housing cavity 112. The adjustment member 106 has an axis X of the adjustment member and can rotate about the axis X of the adjustment member relative to the housing 102. The limiting member 107 is connected to the adjustment member 106 for hindering the movement of the adjustment member 106 relative to the housing 102 along the axis X of the adjustment member. In an aspect of the present disclosure, the limiting member 107 is a limiting ring. The motion converter 130 is configured such that rotation of the adjustment member 106 around the axis X of the adjustment member drives the positioning component 104 to move relative to the housing 102 in the first direction. The axis X of the adjustment member is substantially perpendicular to the first direction. The axis X of the adjustment member extends in left and right directions.

It should be noted that in order to ensure that the descriptions of the orientations of the figures are consistent, the present disclosure is described based on the orientation shown in FIG. 1B. That is, the left and right directions are defined as an extension direction of the axis X of the adjustment member, the upper and lower directions are defined as an extension direction of the first direction (vertical direction), and a second direction is defined as a direction substantially perpendicular to the axis X of the adjustment member and the first direction.

In addition, the fastening assembly further comprises a limiting structure 141, a positioning structure 143, and an indicating structure 146. The limiting structure 141 is provided on the adjustment member 106 and the housing 102 and configured to limit a maximum angle of rotation of the adjustment member 106 around the axis X of the adjustment member. The positioning structure 143 is provided on the adjustment member 106 and the housing 102 and configured to hinder the movement of the adjustment member 106 relative to the housing 102. The indicating structure 146 is provided on the adjustment member 106 and the housing 102 and configured to indicating a distance by which the positioning component 104 moves relative to the housing 102 in the first direction.

As shown in FIGS. 1B-1C, the motion converter 130 comprises a slider 108, a first motion conversion structure 131, and a second motion conversion structure 132. The positioning component 104 is provided with a positioning body accommodating portion 116. The slider 108 is accommodated in the positioning body accommodating portion 116 and can move along the axis X of the adjustment member. The first motion conversion structure 131 is provided on the adjustment member 106 and the slider 108 and configured to convert the rotation of the adjustment member 106 around the axis X of the adjustment member into the movement of the slider 108 along the axis X of the adjustment member. The first motion conversion structure 131 is of a threaded structure comprising an internal thread 142 provided on the slider 108 and an external thread 144 provided on the adjustment member 106. The second motion conversion structure 132 is provided on the slider 108 and the positioning component 104 and configured to convert the movement of the slider 108 along the axis X of the adjustment member into the movement of the positioning component 104 in the first direction. Further, the second motion conversion structure is configured such that the distance of movement of the positioning body along the first direction increases as the distance of movement of the slider along the axis of the adjusting member increases. In a first aspect of the second motion conversion structure 132, the second motion conversion structure 132 is configured such that a distance by which the slider 108 moves along the axis X of the adjustment member are directly proportional to a distance by which the positioning component 104 moves in the first direction. The second motion conversion structure 132 comprises slider inclined portions provided on the slider 108 and positioning component inclined portions provided on the positioning component 104.

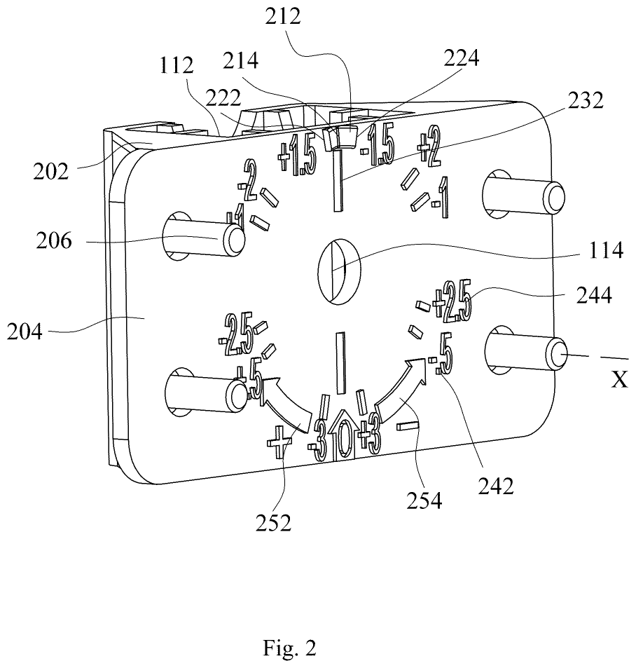

FIG. 2 is a perspective view of the housing 102 shown in FIG. 1C. As shown in FIG. 2, the housing 102 comprises a housing body 202 and a side plate 204. The side plate 204 is arranged on a right side of the housing body 202 and connected to the housing body 202. Specifically, the side plate 204 is formed by extending in the front and rear directions. The housing cavity 112 is formed by extending downwardly from an upper surface of the housing body 202 for accommodating the positioning component 104 and the slider 108. The size of the housing cavity 112 in the left and right directions is greater than the size of the slider 108 in the left and right directions, so as to enable the slider 108 to move within the housing cavity 112 in the left and right directions. The hole 114 extends in the left and right directions and extends through the housing body 202 and the side plate 204 such that the adjustment member 106 can extend through the hole 114 into the housing cavity 112. Four housing positioning members 206 are provided on the housing 102. The housing positioning member 206 is formed by extending from a right surface of the side plate 204 of the housing 102 to the right. The housing positioning member 206 is configured to extend into a first part hole of the first part 1001 to be connected (see FIG. 10A). In other words, the housing positioning member 206 can position the housing 102 relative to the first part 1001 to be connected in the direction of the axis X of the adjustment member.

As shown in FIG. 2, the limiting structure 141 comprises a boss 212 provided on the housing 102. The boss 212 is formed by extending from the right surface of the side plate 204 to the right. The boss 212 forms a first stop surface 222 (i.e., a front stop surface) and a second stop surface 224 (i.e., a rear stop surface) arranged opposite to each other in the front and rear directions. The boss 212 is provided with a boss accommodating portion 214. The boss accommodating portion 214 is recessed to the left from a right surface of the boss 212, such that the cross section of the right surface of the boss 212 forms a V-shape.

As shown in FIG. 2, the positioning structure 143 comprises two grooves 232 provided on the housing 102. The two grooves 232 are arranged above and below the hole 114, respectively, and are recessed to the left from the right surface of the side plate 204. The two grooves 232 extend in a radial direction of the hole 114.

It should be noted that although in the present disclosure the positioning structure 143 comprises two grooves 232, the positioning structure 143 comprising at least one groove 232 is within the scope of protection of the present disclosure.

As shown in FIG. 2, the indicating structure 146 comprises an indicating area 242 provided on the housing 102. The indicating area 242 is located on the right surface of the side plate 204. The indicating area 242 is arranged in the circumferential direction of the hole 114, and the adjustment member 106 does not obscure the indicating area 242 when the adjustment member 106 is mounted in place on the housing 102. A plurality of numerical values 244 are indicated on the indicating area 242. In the present disclosure, the plurality of numerical values 244 comprise positive numbers, number 0, and negative numbers. The number 0 is located below the hole 114 and arranged opposite the boss 212. Arrows 252 and 254 are further respectively provided on two sides of the 0 on the indicating area 242, and show the positive and negative directions indicated by the arrows. In the present disclosure, starting from the number 0, the numerical values indicated in the counter-clockwise direction around the axis X of the adjustment member are negative and the absolute values of the negative numbers increase in the counter-clockwise direction. Starting from the number 0, the numerical values indicated in the clockwise direction around the axis X of the adjustment member are positive and the values of the positive numbers increase in the clockwise direction.

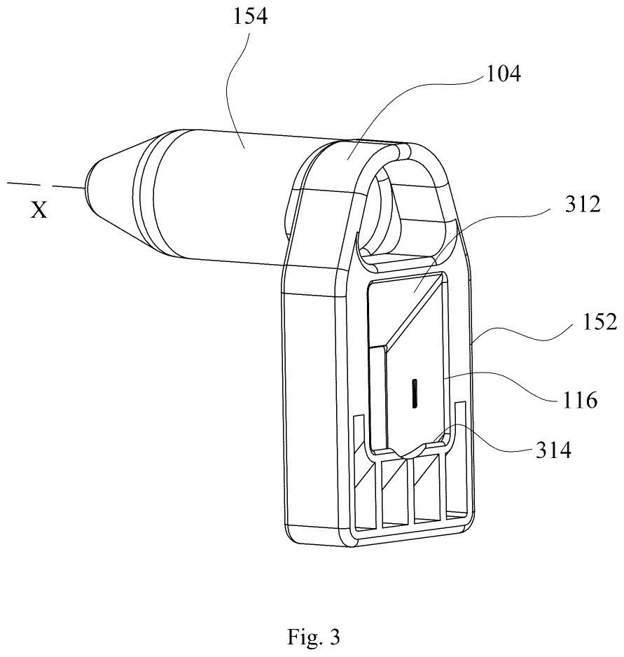

FIG. 3 is a perspective view of the positioning component 104 shown in FIG. 1C. As shown in FIG. 3, the positioning pin 154 is arranged above the positioning body 152 and connected to the positioning body 152. The positioning pin 154 is formed by extending along the axis X of the adjustment member and configured to extend into a second part hole of the second part 1002 to be connected (see FIG. 10A). In other words, the positioning pin 154 enables the positioning component 104 to be positioned relative to the second part 1002 in the direction of the axis X of the adjustment member.

As shown in FIG. 3, the positioning body 152 is generally a cuboid. The positioning body 152 is provided with a positioning body accommodating portion 116 for accommodating the slider 108. The positioning body accommodating portion 116 extends through the positioning body 152 in the left and right directions, so as to enable the slider 108 to move relative to the positioning body 152 in the left and right directions. The positioning component inclined portions of the second motion conversion structure 132 comprise a first positioning component inclined portion 312 and a second positioning component inclined portion 314. The first positioning component inclined portion 312 and the second positioning component inclined portion 314 are inclined surfaces, forming an upper surface and a lower surface, respectively, of the positioning body accommodating portion 116. The upper and lower surfaces are located on opposite sides of the positioning body accommodating portion 116 in the first direction. The two inclined surfaces have the same inclination angle.

FIG. 4 is a perspective view of the slider 108 shown in FIG. 1C. As shown in FIG. 4, the slider 108 comprises a first slider inclined portion 402 and a second slider inclined portion 404 arranged opposite to each other. The first slider inclined portion 402 and the second slider inclined portion 404 are located on opposite sides of the slider 108 in the first direction. The first slider inclined portion 402 and the second slider inclined portion 404 are inclined surfaces, and the inclination angle of the first slider inclined portion 402 and the second slider inclined portion 404 is the same as the inclination angle of the first positioning component inclined portion 312 and the second positioning component inclined portion 314. In other words, in the cross section formed by the first direction and the axis X of the adjustment member, the slope of the inclined surface is a constant not equal to 0 (i.e., the slope of the inclined surface is constant).

In this way, when the slider 108 is accommodated in the positioning body accommodating portion 116, the movement of the slider 108 along the axis X of the adjustment member can be transmitted to the first positioning component inclined portion 312 and the second positioning component inclined portion 314 via the first slider inclined portion 402 and the second slider inclined portion 404, so as to move the positioning body 152 in the first direction. The distance by which the slider 108 moves along the axis X of the adjustment member is directly proportional to the distance by which the positioning body 152 moves in the first direction. For example, for every 1 mm of movement of the slider 108 along the axis X of the adjustment member, the positioning body 152 moves 0.2 cm in the first direction.

As shown in FIG. 4, the slider 108 is further provided with an adjustment member hole 406. The adjustment member hole 406 extends through the slider 108 along the axis X of the adjustment member. The adjustment member hole 406 is provided with an internal thread 142 on an inner wall thereof for cooperating with the external thread 144 of the adjustment member 106.

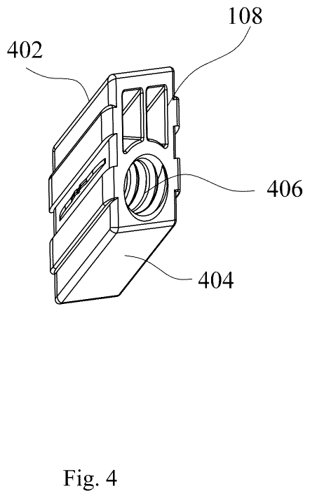

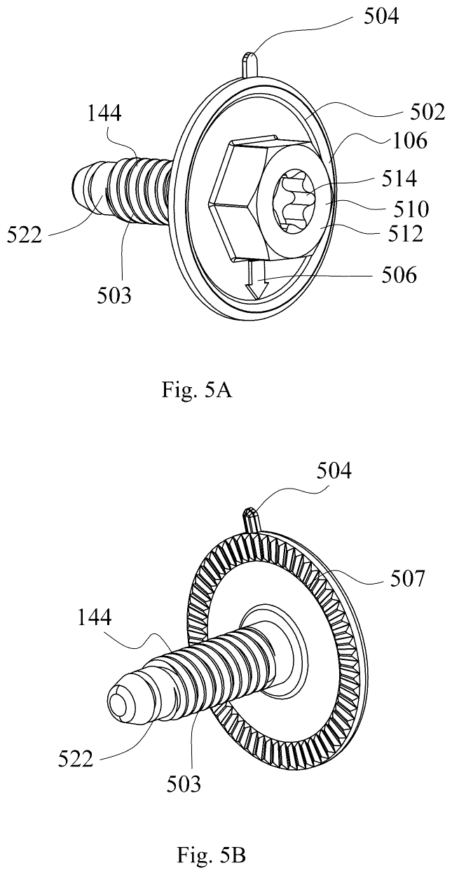

FIGS. 5A-5B are perspective views of the adjustment member 106 shown in FIG. 1C in different orientations. As shown in FIGS. 5A-5B, the adjustment member 106 comprises an adjustment member head 502 and an adjustment member tail 503. The adjustment member head 502 is generally disk-shaped. The adjustment member head 502 is provided with an operating portion 510. The operating portion 510 is configured to cooperate with a tool (not shown, e.g., a screwdriver) to enable the tool to rotate the adjustment member 106 by rotating the operating portion 510. Specifically, the operating portion 510 comprises an operating protrusion 512. The operating protrusion 512 is formed by extending from a right surface of the adjustment member head 502 to the right. The operating protrusion 512 is provided with a recess 514. The shape of an inner wall of the recess 514 matches the shape of the tool. The adjustment member tail 503 is located on a left side of the adjustment member head 502 and connected to the adjustment member head 502. The adjustment member tail 503 is generally cylindrical. The external thread 144 is provided on an outer surface of the adjustment member tail 503. In addition, an end of the adjustment member tail 503 away from the adjustment member head 502 is further provided with a limiting recess 522 for accommodating the limiting member 107 (see FIGS. 1B-1C). Specifically, the limiting member 107 is annular and can be accommodated in the limiting recess 522. The limiting member 107 is configured to block the movement of the adjustment member 106 to the right along the axis X of the adjustment member.

As shown in FIG. 5A, the limiting structure 141 further comprises a tab 504 provided at the adjustment member head 502. The tab 504 is formed by protruding outwardly from the adjustment member head 502 in a radial direction of the adjustment member head 502. The tab 504 can be accommodated in the boss accommodating portion 214 of the housing 102. The tab 504 can also leave the boss accommodating portion 214 and rotate around the axis X of the adjustment member between the first stop surface 222 and the second stop surface 224. Specifically, after the tab 504 leaves the boss accommodating portion 214, the first stop surface 222 and the second stop surface 224 can abut against the tab 504 to hinder the rotation of the tab 504.

As shown in FIG. 5A, the indicating structure 146 further comprises a pointer 506 provided at the adjustment member head 502. The pointer 506 is arranged on the right surface of the adjustment member head 502. It is arranged in the radial direction of the adjustment member head 502. When the adjustment member 106 is assembled in place on the housing 102, the pointer 506 points at the indicating area 242 on the housing 102 and points at a numerical value in the indicating area 242. The numerical value pointed by the pointer 506 represents the distance by which the positioning component 104 moves relative to the housing 102 in the first direction.

As shown in FIG. 5B, the positioning structure 143 further comprises a plurality of raised ribs 507 provided on the adjustment member head 502. The plurality of raised ribs 507 are formed by extending from a left surface of the adjustment member head 502 to the left away from the adjustment member head 502. The plurality of raised ribs 507 are arranged in the circumferential direction of the adjustment member head 502, so that two of the plurality of raised ribs 507 can be respectively accommodated in the grooves 232 of the housing 102 when the adjustment member 106 is assembled in place on the housing 102 (see FIG. 2).

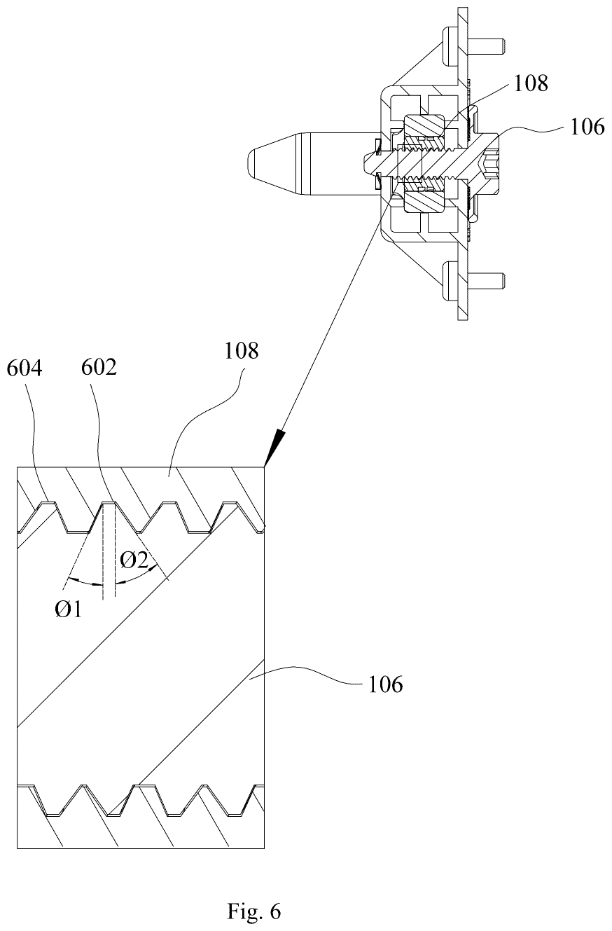

FIG. 6 is a cross-sectional view of the fastening assembly, showing the specific shape of the section (i.e., cross section) of the internal thread 142 on the slider 108 and the external thread 144 provided on the adjustment member 106. As shown in FIG. 6, each of the internal thread 142 and the external thread 144 has a first thread 602 and a second thread 604 having different cross sections. In other words, the profiles of the first thread 602 and the second thread 604 are different. The first thread 602 and the second thread 604 are alternately arranged in the direction of the axis X of the adjustment member. Specifically, in an aspect of the present disclosure, the first thread 602 and the second thread 604 are both serrated. A left flank angle φ1 of the first thread 602 is 24°, and a right flank angle φ2 of the first thread 602 is 36°. A left flank angle φ1 of the second thread 604 is 36°, and a right flank angle φ2 of the second thread 604 is 24°.

It should be noted that although the first thread 602 and the second thread 604 in the present disclosure have the same thread angle (i.e., the sum of the left and right flank angles), the first thread 602 and the second thread 604 may have different thread angles in other aspects.

It should also be noted that although the profiles of the first thread 602 and the second thread 604 are different in the present disclosure, the profiles of the first thread 602 and the second thread 604 may be the same in other aspects.

The adjustment member 106 of the present disclosure has an initial position, a first extreme position, and a second extreme position. The adjustment member 106 is in the initial position when the fastening assembly is assembled in place. The adjustment member 106 can rotate around the axis X of the adjustment member from the initial position to the first extreme position or from the initial position to the second extreme position.

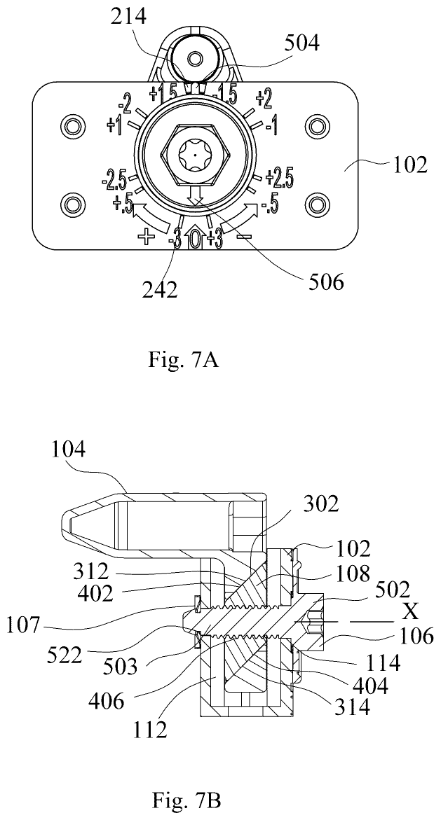

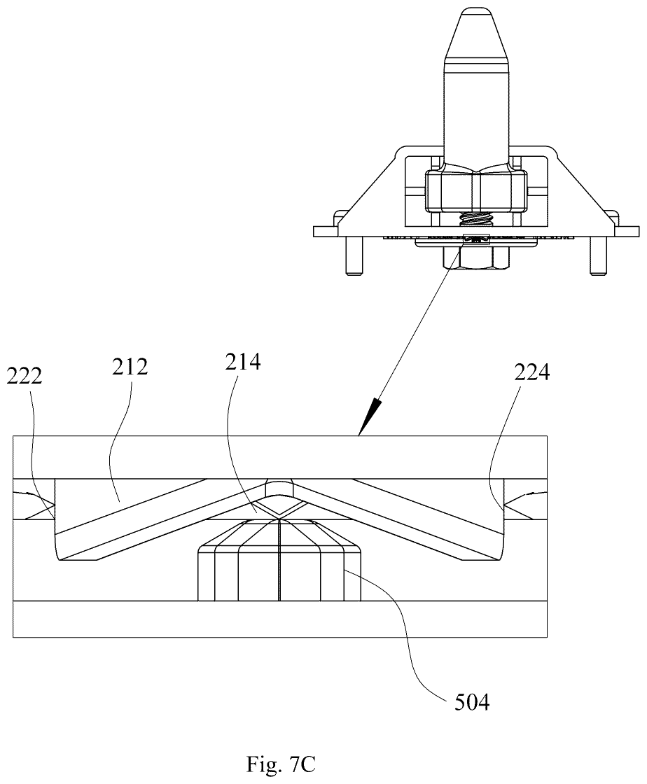

FIG. 7A is a front view of the fastening assembly according to the first aspect of the present disclosure, FIG. 7B is a cross-sectional view of the fastening assembly according to the first aspect of the present disclosure, and FIG. 7C is a top view of the fastening assembly according to the first aspect of the present disclosure. As shown in FIGS. 7A-7C, the adjustment member 106 is in the initial position when the fastening assembly is assembled in place. An exemplary process in which an operator assembles the fastening assembly in place is described below.

The operator may first insert the slider 108 into the positioning body accommodating portion 116 of the positioning component 104 such that the first slider inclined portion 402 abuts against the first positioning component inclined portion 312, and that the second slider inclined portion 404 abuts against the second positioning component inclined portion 314. The operator then inserts the slider 108 and the positioning component 104 together into the housing cavity 112 of the housing 102 and align the adjustment member hole 406 in the slider 108 with the hole 114 in the housing 102. The operator then inserts the adjustment member 106 into the hole 114 of the housing 102 and the adjustment member hole 406 and screws the adjustment member 106 until the pointer 506 is aligned with the number 0 in the indicating area 242, and the tab 504 of the adjustment member 106 is accommodated in the boss accommodating portion 214 of the housing 102. The operator fits the limiting member 107 over the adjustment member tail 503 of the adjustment member 106 such that the limiting member 107 is accommodated in the limiting recess 522. In this way, the adjustment member tail 503 has its left side limited by the limiting member 107 and its right side limited by the adjustment member head 502, and is thus retained in place. Thus, the fastening assembly is assembled in place and the adjustment member 106 is in the initial position.

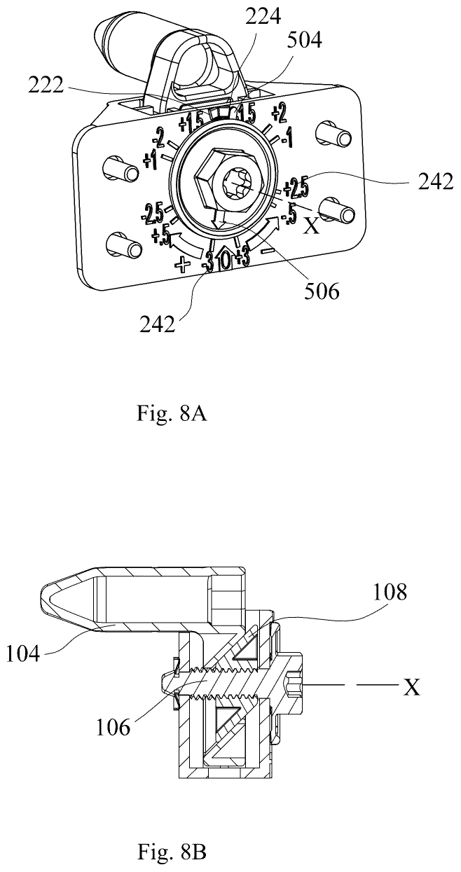

FIG. 8A is a perspective view of the fastening assembly according to the first aspect of the present disclosure, and FIG. 8B is a cross-sectional view of the fastening assembly according to the first aspect of the present disclosure, with the adjustment member 106 in the first extreme position. As shown in FIGS. 8A-8B, when the adjustment member 106 is in the first extreme position, the tab 504 of the adjustment member 106 abuts against the second stop surface 224 of the tab 504. The pointer 506 of the adjustment member 106 points at the number −3 in the indicating area 242 on the housing 102.

Referring to FIGS. 7A-8B, during movement of the adjustment member 106 from the initial position to the first extreme position, the adjustment member 106 rotates around the axis X of the adjustment member in the counter-clockwise direction. As the adjustment member 106 rotates around the axis X of the adjustment member in the counter-clockwise direction, the adjustment member 106 deforms slightly, the tab 504 accommodated in the boss accommodating portion 214 passes over the first stop surface 222 and leaves the boss accommodating portion 214 under the guide of a wall surface of the boss accommodating portion 214.

As shown in FIGS. 8A-8B, during the movement of the adjustment member 106 from the initial position to the first extreme position, the rotation of the adjustment member 106 around the axis X of the adjustment member drives the slider 108 to move to the right along the axis X of the adjustment member by means of the threaded structure, such that the positioning component 104 moves downwardly in the first direction with the cooperating between the slider inclined portions and the positioning component inclined portions. When the adjustment member 106 is in the first extreme position, the pointer 506 of the adjustment member 106 points at the number −3 in the indicating area 242, which represents a downward movement of the positioning component 104 by 3 mm in the first direction.

It should be note that when the adjustment member 106 is in the first extreme position, the tab 504 of the adjustment member 106 abuts against the second stop surface 224 of the tab 504. The second stop surface 224 blocks the adjustment member 106 from continuing to rotate around the axis X of the adjustment member in the counter-clockwise direction.

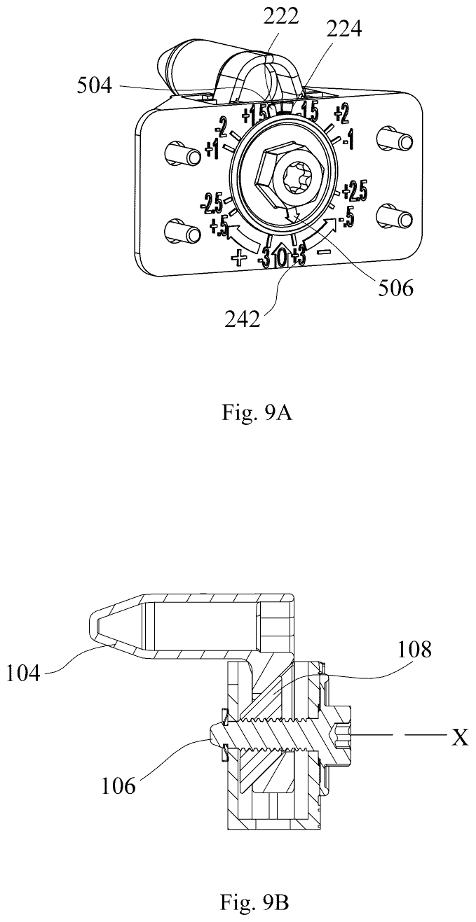

FIG. 9A is a perspective view of the fastening assembly according to the first aspect of the present disclosure, and FIG. 9B is a cross-sectional view of the fastening assembly according to the first aspect of the present disclosure, with the adjustment member 106 in the second extreme position. As shown in FIGS. 9A-9B, when the adjustment member 106 is in the second extreme position, the tab 504 of the adjustment member 106 abuts against the first stop surface 222 of the tab 504. The pointer 506 of the adjustment member 106 points at the number +3 in the indicating area 242 on the housing 102.

Referring to FIGS. 7A-7C and 9A-9B, during movement of the adjustment member 106 from the initial position to the second extreme position, the adjustment member 106 rotates around the axis X of the adjustment member in the clockwise direction. As the adjustment member 106 rotate around the axis X of the adjustment member in the clockwise direction, the adjustment member 106 deforms slightly, the tab 504 accommodated in the boss accommodating portion 214 passes over the second stop surface 224 and leaves the boss accommodating portion 214 under the guide of a wall surface of the boss accommodating portion 214.

As shown in FIGS. 9A-9B, during the movement of the adjustment member 106 from the initial position to the second extreme position, the rotation of the adjustment member 106 around the axis X of the adjustment member drives the slider 109 to move to the left along the axis X of the adjustment member by means of the threaded structure, such that the positioning component 104 moves upwardly in the first direction with the cooperating between the slider inclined portions and the positioning component inclined portions. When the adjustment member 106 is in the second extreme position, the pointer 506 of the adjustment member 106 points at the number +3 in the indicating area 242, which represents an upward movement of the positioning component 104 by 3 mm in the first direction.

It should be note that when the adjustment member 106 is in the second extreme position, the tab 504 of the adjustment member 106 abuts against the first stop surface 222 of the tab 504. The first stop surface 222 blocks the adjustment member 106 from continuing to rotate around the axis X of the adjustment member in the clockwise direction.

In the present disclosure, since the first motion conversion structure 131 is of a threaded structure and the slider inclined portions and the positioning component inclined portions are inclined flat surfaces, when the adjustment member 106 rotates around the axis X of the adjustment member, the angle of rotation of the adjustment member 106 around the axis X of the adjustment member is directly proportional to the distance by which the slider 108 moves along the axis X of the adjustment member and the distance by which the positioning component 104 moves in the first direction.

In this way, with the rotation of the adjustment member 106 around the axis X of the adjustment member, the movement of the positioning component 104 relative to the housing 102 in the first direction can be achieved.

FIGS. 10A-10B are diagrams of the process of connecting the first part 1001 to the second part 1002 via the fastening assembly according to the first aspect of the present disclosure. The first part 1001 is provided with a first part hole (not shown) for accommodating the housing positioning member 206 of the housing 102. The fastening assembly is connected to the first part 1001 via the housing positioning member 206 of the housing 102. The second part 1002 is provided with a second part hole 1004 for accommodating the positioning pin 154. The fastening assembly is connected to the second part 1002 via the positioning pin 154. After the first part 1001 and the second part 1002 are connected in place via the fastening assembly, a top surface 1011 of the first part 1001 is flush with a top surface 1012 of the second part 1002.

Referring to FIGS. 10A-10B, an exemplary process of connecting the first part 1001 to the second part 1002 via the fastening assembly will be described below. As shown in FIGS. 10A-10B, an operator inserts the housing positioning member 206 of the fastening assembly assembled in place (i.e., the adjustment member 106 being in the initial position) into the first part hole of the first part 1001, so as to connect the housing 102 of the fastening assembly to the first part 1001. The operator then inserts the positioning pin 154 of the fastening assembly assembled in place into the second part hole 1004 in the second part 1002, so as to connect the positioning component 104 of the fastening assembly to the second part 1002. As can be seen with reference to FIG. 10A, when the housing positioning member 206 is inserted into the first part hole and the positioning pin 154 is inserted into the second part hole 1004, the top surface 1011 of the first part 1001 has a height difference D from the top surface 1012 of the second part 1002. In this case, the operator may rotate the adjustment member 106 around the axis X of the adjustment member in the clockwise direction, such that the positioning pin 154 moves upwardly relative to the housing 102 in the first direction until the top surface 1011 of the first part 1001 is flush with the top surface 1012 of the second part 1002. When the top surface 1011 of the first part 1001 is flush with the top surface 1012 of the second part 1002, the operator may release the adjustment member 106. Two of the plurality of raised ribs 507 (see FIG. 5B) on the adjustment member 106 are respectively accommodated in the grooves 232 (see FIG. 2) on the housing 102, such that the adjustment member 106 is retained in place relative to the housing 102. In addition, the operator may observe the specific number in the indicating area 242 that the pointer 506 points at, to know the distance by which the adjustment member 106 moves relative to the housing 102.

In this way, the fastening assembly of the present disclosure can connect the first part 1001 to the second part 1002 with the first part hole and the second part hole 1004 positioned with deviations from their preset positions, and enable the connected first part 1001 and second part 1002 to be in the preset positions (e.g., the top surface 1011 of the first part 1001 is flush with the top surface 1012 of the second part 1002).

It should be noted that although the motion converter 130 in the present disclosure comprises the slider 108, the first motion conversion structure 131 and the second motion conversion structure 132, in other aspects, any motion converter configured such that rotation of the adjustment member 106 around the axis of the adjustment member drives the positioning body 152 to move relative to the housing 102 in the first direction is within the scope of protection of the present disclosure.

It should also be noted that although the first motion conversion structure 131 in the present disclosure is of a threaded structure, in other aspects, any first motion conversion structure configured to convert the rotation of the adjustment member 106 around the axis X of the adjustment member into the movement of the slider 108 along the axis X of the adjustment member is within the scope of protection of the present disclosure.

It should also be noted that although the slider inclined portions provided on the slider 108 and the positioning component inclined portions provided on the positioning component 104 in the present disclosure are both inclined flat surfaces, and the left end of each inclined portion is lower than the right end of the inclined portion, in other aspects, the inclined portion may have other shapes (e.g., inclined curved surfaces), or the left end of the inclined portion is higher than the right end of the inclined portion.

Further, although the second motion conversion structure 132 in the present disclosure comprises the slider inclined portions provided on the slider 108 and the positioning component inclined portions provided on the positioning component 104, in other aspects, any second motion conversion structure configured to convert the movement of the slider 108 around the axis X of the adjustment member into the movement of the positioning component 104 in the first direction is within the scope of protection of the present disclosure.

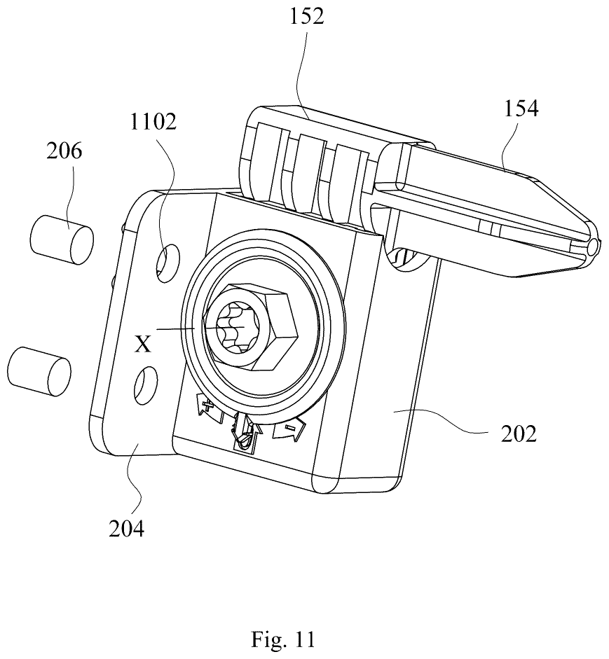

FIG. 11 is a perspective view of a fastening assembly according to a second aspect of the present disclosure. The similarities between the second aspect of the fastening assembly shown in FIG. 11 and the first aspect of the fastening assembly shown in FIGS. 1A-9B are not described in detail, and the main differences are that the housing positioning member 206 is provided separately from the housing 102, and the housing positioning member 206 and the positioning pin 154 are configured to be connected to a first part and a second part (not shown) to be connected, respectively. The first part and the second part are located on opposite sides of the fastening assembly in a second direction substantially perpendicular to the axis X of the adjustment member and the first direction.

Specifically, as shown in FIG. 11, the side plate 204 is formed by extending from the housing body 202 along the axis X of the adjustment member. The side plate 204 is provided with a hole 1102. The hole 1102 extends through the side plate 204 in the second direction and is configured to accommodate the housing positioning member 206. The housing positioning member 206 can extend into the hole 1102 and is configured to extend into a hole (not shown) in the first part to be connected, so as to position the housing 102 relative to the first part. In other words, the housing positioning member 206 can position the housing 102 relative to the first part in the second direction. As an example, the housing positioning member 206 is a positioning post.

As shown in FIG. 11, the positioning pin 154 is connected to the positioning body 152 and is formed by extending in the second direction. The positioning pin 154 is configured to extend into the second part hole (not shown) of the second part to be connected, so as to position the positioning pin 154 relative to the second part. In other words, the positioning pin 154 enables the positioning component 104 to be positioned relative to the second part 1002 in the second direction.

In this way, the fastening assembly according to the second aspect of the present disclosure can connect the first part and the second part that are on two sides of the fastening assembly in the second direction.

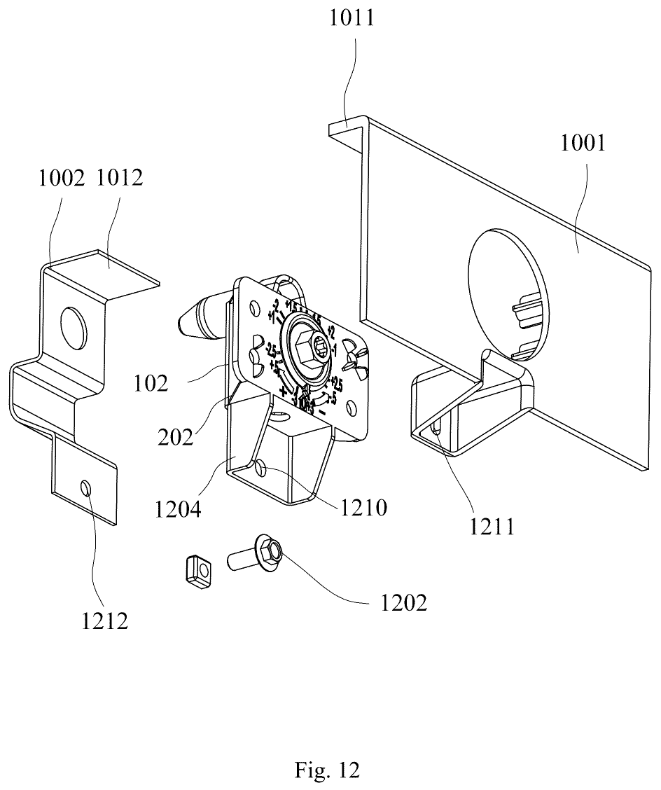

FIG. 12 is a perspective view of the fastening assembly according to a third aspect of the present disclosure. The similarities between the third aspect of the fastening assembly shown in FIG. 12 and the first aspect of the fastening assembly shown in FIGS. 1A-9B are not described in detail, and the main difference is that the fastening assembly further comprises a connecting component 1202. The connecting component 1202 is configured to extend through the housing 102 and to connect the housing 102, the first part 1001 and the second part 1002 together.

Specifically, as shown in FIG. 12, the housing 102 further comprises an additional connecting plate 1204. The additional connecting plate 1204 is connected to the housing body 202 and is formed by extending downwardly from the housing body 202. The additional connecting plate 1204 is provided with an additional connecting hole 1210. The additional connecting hole 1210 extends through the additional connecting plate 1204 along the axis X of the adjustment member. The first part 1001 is provided with a first part additional hole 1211. The second part 1002 is provided with a second part additional hole 1212. After the fastening assembly causes the top surface 1011 of the first part 1001 to be flush with the top surface 1012 of the second part 1002, the additional connecting hole 1210, the first part additional hole 1211 and the second part additional hole 1212 are aligned with one another, and the connecting component 1202 passes through the additional connecting hole 1210, the first part additional hole 1211 and the second part additional hole 1212, so as to connect the first part 1001, the second part 1002 and the housing 102 together.

In this way, the fastening assembly according to the third aspect of the present disclosure can further enhance the connection between the first part 1001, the second part 1002 and the housing 102.

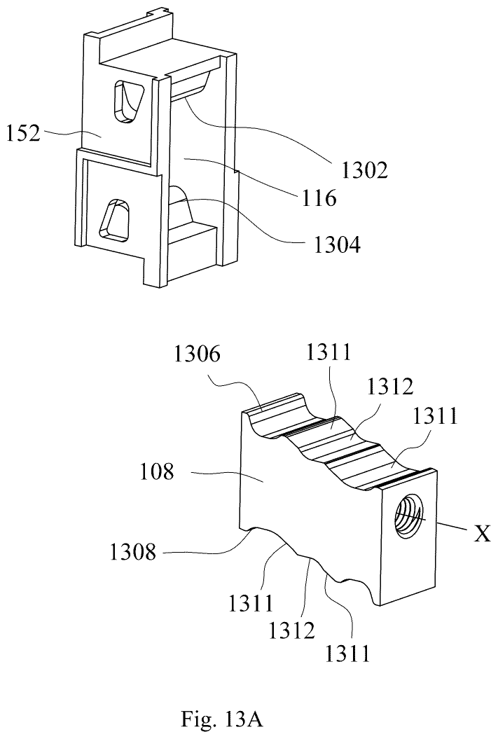

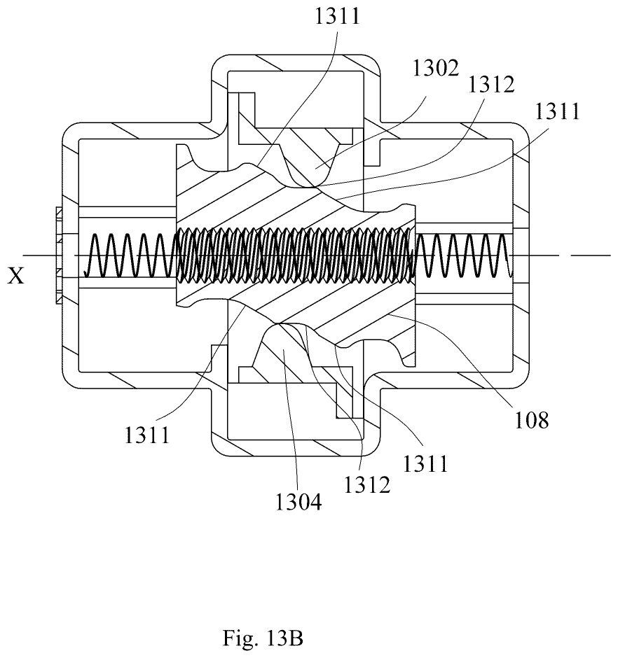

FIG. 13A is an exploded view of a second aspect of the second motion conversion structure 132, the slider 108 and the positioning body 152 of the present disclosure, and FIG. 13B is a vertical cross-sectional view of the second aspect of the second motion conversion structure 132, the slider 108 and the positioning body 152 shown in FIG. 13A. The similarities between the second aspect of the second motion conversion structure 132 as shown in FIGS. 13A-13B and the first aspect of the second motion conversion structure 132 as shown in FIGS. 1A-9B are not described in detail, and the main difference is that in the first aspect of the second motion conversion structure 132, the distance by which the slider 108 moves along the axis X of the adjustment member is directly proportional to the distance by which the positioning body 152 moves in the first direction, while in the second aspect of the second motion conversion structure 132, the distance by which the slider 108 moves along the axis X of the adjustment member is not directly proportional to the distance by which the positioning body 152 moves in the first direction.

Specifically, as shown in FIGS. 13A-13B, the second motion conversion structure 132 is provided on the slider 108 and the positioning component 104. The second motion conversion structure 132 comprises slider cooperating portions provided on the slider 108 and protrusions provided on the positioning component 104. The slider cooperating portions of the second motion conversion structure 132 comprise a first slider cooperating portion 1306 and a second slider cooperating portion 1308. The first slider cooperating portion 1306 and the second slider cooperating portion 1308 are located on opposite sides of the slider 108 in the first direction. Each of the first slider cooperating portion 1306 and the second slider cooperating portion 1308 includes two first stage sections 1311 and a second stage section 1312. In the direction of the axis X of the adjustment member, the second stage section 1312 is disposed between the two first stage sections 1311 and is smoothly connected to an adjacent first stage section 1311. The first stage section 1311 is an inclined surface having a first slope, and the second stage section 1312 is an inclined surface having a second slope different from the first slope. The first stage section 1311 is capable of increasing the distance of movement of the positioning body 152 along the first direction at a first speed with the increase of the distance of movement of the slider 108 along the axis X of the adjustment member. The second stage section 1312 is capable of increasing the distance of movement of the positioning body 152 along the first direction at a second speed different from the first speed with the increase of the distance of movement of the slider 108 along the axis X of the adjustment member. In other words, slopes of outer contour lines of the first slider cooperating portion 1306 and the second slider cooperating portion 1308 are variable in a cross section defined by the first direction and the axis X of the adjustment member.

As shown in FIGS. 13A-13B, the protrusions of the second motion conversion structure 132 comprise a first protrusion 1302 and a second protrusion 1304 which are arranged on the slider 108. The first protrusion 1302 and the second protrusion 1304 are located on opposite sides of the positioning body accommodating portion 116 in the first direction and are formed by protruding from an inner wall of the positioning body accommodating portion 116. The first protrusion 1302 cooperates with the first slider cooperating portion 1306, and the second protrusion 1304 cooperates with the second slider cooperating portion 1308.

In this way, when the slider 108 is accommodated in the positioning body accommodating portion 116, the movement of the slider 108 along the axis X of the adjustment member can be transmitted to the first protrusion 1302 and the second protrusion 1304 via the first slider cooperating portion 1306 and the second slider cooperating portion 1308, so as to move the positioning body 152 in the first direction. The distance by which the slider 108 moves along the axis X of the adjustment member is not directly proportional to the distance by which the positioning body 152 moves in the first direction.

In this aspect, the first speed is greater than the second speed and the second speed is equal to 0. Because the second speed is equal to 0 (i.e., the second slope of the second stage section 1312 is 0), when the protrusions (i.e., the first protrusion 1302 and the second protrusion 1304) on the positioning component 104 are moved in cooperation with the second stage section 1312 on the slider 108, the distance of the movement of the positioning body 152 in the first direction does not increase with the movement of the slider 108 along the axis X of the adjustment member. That is, during the entire cooperative movement of the protrusion on the positioning member 206 with the two first stage sections 1311 and the second stage section 1312 on the slider 108, the distance that the positioning body 152 moves along the first direction does not increase at each moment with the increase of the distance that the slider 108 moves along the axis X of the adjustment member. However, this situation should also be considered to be included in the present application in that the distance of movement of the positioning body 152 along the first direction increases with the increase of the distance of movement of the slider 108 along the axis X of the adjustment member, because during the entire cooperative movement of the positioning component 104 with the slider 108 (i.e., the entire cooperative movement of the protrusions on the positioning component 104 with the two first stage sections 1311 and the second stage section 1312 on the slider 108), there remains a tendency for the distance of movement of the positioning body 152 along the first direction to increase as the distance of movement of the slider 108 along the axis X of the adjustment member increases.

It should be noted that while in the present aspect, the second slope is 0, in other aspects, the second slope may not be 0.

It should be noted that while in the present application, each of the first slider cooperating portion 1306 and the second slider cooperating portion 1308 includes two first stage sections 1311 and a second stage section 1312, in other aspects, each of the first slider cooperating portion 1306 and the second slider cooperating portion 1308 may include at least one first stage section 1311 and at least one second stage section 1312.

It should be noted that although the second motion conversion structure 132 in the present aspect comprises the slider cooperating portions provided on the slider 108 and the protrusions provided on the positioning component 104, in other aspects, the second motion conversion structure may comprise protrusions provided on the slider 108 and cooperating portions provided on the positioning component 104.

Although the present disclosure is described with reference to the examples of aspects outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting. Therefore, the disclosure in this specification may be used to solve other technical problems and have other technical effects and/or may solve other technical problems. Accordingly, the examples of the aspects of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

1. A fastening assembly comprising:
a housing defining a housing cavity;
a positioning body being accommodated inside the housing cavity and movable relative to the housing in a first direction;
an adjustment member being rotatable around an axis of the adjustment member relative to the housing; and
a motion converter being configured such that rotation of the adjustment member around the axis of the adjustment member drives the positioning body to move relative to the housing in the first direction.

2. The fastening assembly according to claim 1, wherein
the axis of the adjustment member is substantially perpendicular to the first direction.

3. The fastening assembly according to claim 1, wherein
the motion converter comprises a slider, a first motion conversion structure, and a second motion conversion structure, wherein the slider is accommodated inside the housing cavity and movable relative to the housing along the axis of the adjustment member;
the first motion conversion structure is provided on the adjustment member and the slider and configured to convert the rotation of the adjustment member around the axis of the adjustment member into movement of the slider along the axis of the adjustment member; and
the second motion conversion structure is provided on the slider and the positioning body and configured to convert movement of the slider along the axis of the adjustment member into movement of the positioning body in the first direction.

4. The fastening assembly according to claim 3, wherein
the positioning body is provided with a positioning body accommodating portion, and the slider is arranged inside the positioning body accommodating portion.

5. The fastening assembly according to claim 3, wherein
the first motion conversion structure comprises a threaded structure.

6. The fastening assembly according to claim 5, wherein
the threaded structure comprises an internal thread and an external thread which cooperate with each other;
wherein the slider is provided with an adjustment member hole, and the internal thread is provided on an inner wall of the adjustment member hole; and
wherein the external thread is provided on the adjustment member.

7. The fastening assembly according to claim 5, wherein
the threaded structure comprises a first thread and a second thread having different cross sections.

8. The fastening assembly according to claim 3, wherein
the second motion conversion structure is configured such that a distance of movement of the positioning body along the first direction increases as the distance of movement of the slider along the axis of the adjustment member increases.

9. The fastening assembly according to claim 8, wherein
the second motion conversion structure comprises a first positioning component inclined portion and a second positioning component inclined portion formed by an inner wall of the positioning body accommodating portion, and a first slider inclined portion and a second slider inclined portion provided on the slider;
wherein the first positioning component inclined portion and the second positioning component inclined portion are located on opposite sides of the positioning body accommodating portion in the first direction, the first slider inclined portion and the second slider inclined portion are located on opposite sides of the slider in the first direction, the first positioning component inclined portion cooperates with the first slider inclined portion, and the second positioning component inclined portion cooperates with the second slider inclined portion; and
wherein each of the first positioning component inclined portion, the second positioning component inclined portion, the first slider inclined portion and the second slider inclined portion is an inclined surface with the same slope.

10. The fastening assembly according to claim 3, wherein
the second motion conversion structure comprises a first protrusion and a second protrusion provided on an inner wall of the positioning body accommodating portion, and a first slider cooperating portion and a second slider cooperating portion provided on the slider;
wherein the first protrusion and the second protrusion are located on opposite sides of the positioning body accommodating portion in the first direction and are formed by protruding from the inner wall of the positioning body accommodating portion, the first slider cooperating portion and the second slider cooperating portion are located on opposite sides of the slider in the first direction, the first protrusion cooperates with the first slider cooperating portion, and the second protrusion cooperates with the second slider cooperating portion; and
wherein each of the first slider cooperating portion and the second slider cooperating portion comprises at least one first stage section and at least one second stage section, the at least one first stage section being configured to increase the distance of movement of the positioning body in the first direction at a first speed with the increase of the distance of movement of the slider along the axis of the adjustment member, the second stage section being configured to increase the distance of movement of the positioning body in the first direction at a second speed which is different from the first speed with the increase of the distance of movement of the slider along the axis of the adjustment member.

11. The fastening assembly according to claim 1, further comprising:
a limiting structure being provided on the adjustment member and the housing and configured to limit a maximum angle of rotation of the adjustment member around the axis of the adjustment member.

12. The fastening assembly according to claim 11, wherein
the limiting structure comprises a tab provided on the adjustment member and a boss provided on the housing;
wherein the tab is formed by protruding outwardly from the adjustment member in a radial direction of the adjustment member, and the boss protrudes from a surface of the housing and has a first stop surface and a second stop surface arranged opposite each other in a circumferential direction of the axis of the adjustment member; and
wherein the first stop surface and the second stop surface are capable of abutting against the tab to hinder the rotation of the tab.

13. The fastening assembly according to claim 12, wherein
the boss is provided with a boss accommodating portion;
wherein the fastening assembly is configured such that when the adjustment member and the housing are assembled in place, the tab is accommodated inside the boss accommodating portion.

14. The fastening assembly according to claim 1, further comprising:
a positioning structure being provided on the adjustment member and the housing and configured to hinder movement of the adjustment member relative to the housing.

15. The fastening assembly according to claim 14, wherein
the positioning structure comprises a plurality of raised ribs provided on the adjustment member and at least one groove provided on the housing;
wherein the plurality of raised ribs protrude from a surface of the adjustment member in a radial direction of the adjustment member around the axis of the adjustment member, the at least one groove is recessed in a surface of the housing, and any one of the plurality of raised ribs is capable of being accommodated inside the at least one groove to hinder movement of the adjustment member relative to the housing.

16. The fastening assembly according to claim 1, further comprising:
an indicating structure being configured to indicate a distance by which the positioning body moves relative to the housing in the first direction.

17. The fastening assembly according to claim 16, wherein
the indicating structure comprises an indicating area provided on the housing and a pointer provided on the adjustment member;
wherein the indicating area is arranged around the axis of the adjustment member, and the indicating area is provided with a plurality of numerical values thereon; and
wherein when the pointer points at a numerical value of the plurality of numerical values, the numerical value represents the distance by which the positioning body moves relative to the housing in the first direction.

18. The fastening assembly according to claim 1, further comprising:
a housing positioning member enabling the housing to be positioned relative to a first part in the direction of the axis of the adjustment member; and
a positioning pin being provided on the positioning body and formed by extending in the direction of the axis of the adjustment member to enable the positioning body to be positioned relative to a second part in the direction of the axis of the adjustment member.

19. The fastening assembly according to claim 1, further comprising:
a housing positioning member enabling the housing to be positioned relative to a first part in a second direction substantially perpendicular to the axis of the adjustment member and the first direction; and
a positioning pin being provided on the positioning body and formed by extending in the second direction to enable the positioning body to be positioned relative to a second part in the second direction.

20. The fastening assembly according to claim 1, further comprising:
a connecting component extending through the housing and being configured to connect the housing, a first part and a second part together.
